(19) United States
(12) Patent Application Publication
(10) Pub. No.: US 2024/0147296 A1
(43) Pub. Date: May 2, 2024

(54) INTERFERENCE CONTROL SYSTEM, INTERFERENCE CONTROL METHOD, REPEATER AND PROGRAM FOR INTERFERENCE CONTROL FOR WIRELESS COMMUNICATIONS

(71) Applicant: NIPPON TELEGRAPH AND TELEPHONE CORPORATION, Tokyo (JP)

(72) Inventors: Junichi IWATANI, Musashino-shi, Tokyo (JP); Yasuhiko INOUE, Musashino-shi, Tokyo (JP); Yusuke ASAI, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/567,777

(22) PCT Filed: Jun. 8, 2021
(86) PCT No.: PCT/JP2021/021805

§ 371 Date: Dec. 7, 2023

(51) Int. Cl. H04W 28/02; H04B 17/336; H04W 60/04; H04W 64/00

(52) U.S. Cl. CPC H04W 28/0236; H04B 17/336; H04W 60/04; H04W 64/00

(57) ABSTRACT

Provided is an interference control system for wireless communication suitable for limiting the total amount of interference to which an interfered-with wireless communicator to be protected is subjected by interfering wireless communicators. A repeater disposed between the interfering wireless communicator and a controller includes a processor and a memory storing a program executed by the processor. The processor acquires registration information including a position and a transmission power for each interfering wireless communicator, and estimates, for each interfering wireless communicator, a terminal range in which there is a likelihood that a terminal wireless communicator communicating with the interfering wireless communicator is present based on the position and the transmission power. The processor transmits a registration application including the terminal range to the control device. The control device determines whether or not a resource application from the interfering wireless communicator is possible on the basis of the terminal range.

### TECHNICAL FIELD

This disclosure relates to an interference control system, an interference control method, a repeater and a program for interference control for wireless communications, and more particularly, to an interference control system, an interference control method, a repeater and a program for interference control for wireless communication suitable for limiting the total amount of interference to which an interfered-with device to be protected is subjected by a large number of interfering devices having a wireless communication function.

### BACKGROUND ART

As a technology on the premise of a mixture of an interfered-with device to be protected and a plurality of interfering devices that emit interference signals, a citizens broadband radio service (CBRS) proposed in the United States is known. More specifically, the CBRS is a technology of wireless communication having a function of reducing the total amount of interference with respect to the interfered-with device in a case where the interfered-with device and the interfering device use the same frequency band. Non Patent Literature 1 below describes a technical standard related to CBRS.

In the CBRS, for example, each of an interfered-with device used by the government and a plurality of interfering devices (CBSD: citizens broadband radio service device) for use in the private sector preregister their position information in a control device (SAS: spectrum access system) via a network. The position information described above includes information indicating the latitude and the longitude of each of the interfering devices and whether the devices are installed indoors or outdoors.

Each of the interfering devices transmits an application for use of wireless resources including a frequency to be used and a transmission power to the control device. The control device that has received the application for use estimates the total amount of interference to which the interfered-with device is subjected by all the interfering devices. The total amount of interference is calculated from position information registered in advance for each of the interfered-with device and the interfering device, and an antenna gain, a transmission power, and the like of each device. Then, the control device determines whether or not the application for use is possible depending on whether or not an estimated value of the total amount of interference falls within an allowable value, and returns a result of the determination to the interfering device as a response.

According to such processing, the communication of the interfering device is permitted within a range in which the total amount of interference received by the interfered-with device does not exceed the allowable value. Therefore, according to the CBRS technology, the communication of the interfered-with device to be protected can be appropriately protected.

Note that, in the CBRS, the application and the response between the interfering device and the control device may be directly exchanged, or may be exchanged via a repeater (domain proxy).

### CITATION LIST

### Non Patent Literature

Non Patent Literature 1: CBRS Baseline Standards, WINNF-TS-0016, CBRS WInnForum Standards, 25 Nov. 2020, https://cbrs.wirelessinnovation.org/release-1-of-the-baseline-standard-specifications

### SUMMARY OF INVENTION

### Technical Problem

Incidentally, the interfering device may include, for example, a subscriber device of an optical access service provided by a communication carrier, specifically, an access point of a wireless LAN, or the like. It is assumed that a movable terminal device is present around such an interfering device. Then, these terminal devices become interference sources for the interfered-with devices similarly to the subscriber devices. In addition, under a situation where the terminal device is located closer to the interfered-with device than the subscriber device, the amount of interference caused by the terminal device may be larger than the amount of interference caused by the subscriber device.

However, in the conventional technology related to the CBRS, what is assumed as the interference source is the interfering device itself, and the terminal device is not assumed as the interference source. Therefore, in a case where the terminal device is present around the interfering device, particularly at a position closer to the interfered-with device than the interfering device, a situation may arise in which the total amount of interference received by the interfered-with device is not accurately measured, and communication of the interfered-with device is not sufficiently protected.

The present disclosure has been made in view of the above problems, and a first object of the present disclosure is to provide an interference control system for wireless communication capable of appropriately protecting communication of an interfered-with device even when communication of a terminal device affects a total amount of interference of the interfered-with device by assuming a range in which there is a likelihood that the terminal device is present around an interfering device as a position of an interference source that subjects the interfered-with device to interference.

In addition, a second object of the present disclosure is to provide an interference control method for wireless communication capable of appropriately protecting communication of an interfered-with device even when communication of a terminal device affects a total amount of interference of the interfered-with device by assuming a range in which there is a likelihood that the terminal device is present around an interfering device as a position of an interference source that subjects the interfered-with device to interference.

In addition, a third object of the present disclosure is to provide a repeater for wireless communication capable of appropriately protecting communication of an interfered-with device even when communication of a terminal device affects a total amount of interference of the interfered-with device by assuming a range in which there is a likelihood that the terminal device is present around an interfering device as a position of an interference source that subjects the interfered-with device to interference.

In addition, a fourth object of the present disclosure is to provide an interference control program for wireless communication capable of appropriately protecting communication of an interfered-with device even when communication of a terminal device affects a total amount of interference of the interfered-with device by assuming a range in which there is a likelihood that the terminal device is present around an interfering device as a position of an interference source that subjects the interfered-with device to interference.

### Solution to Problem

In order to achieve the above objects, it is to be desired that a first aspect is an interference control system for wireless communication, the interference control system including: a plurality of interfering devices that perform wireless communication; an interfered-with device whose wireless communication is to be protected; and a control device that controls an amount of interference to which the interfered-with device is subjected by the interfering device,
in which a repeater disposed between the interfering device and the control device includes a processor unit and a memory storing a program executed by the processor unit, and
the processor unit executes:
a process of acquiring registration information including a position and a transmission power for each interfering device;
a process of estimating, for each interfering device, a terminal range in which there is a likelihood that a terminal device communicating with the interfering device is present based on the position and the transmission power; and
an application process of transmitting a registration application including the terminal range to the control device.

Further, it is to be desired that a second aspect is an interference control method for wireless communication using a control device that controls an amount of interference to which an interfered-with device whose wireless communication is to be protected is subjected by a plurality of interfering devices that perform wireless communication, the interference control method including:
a step of acquiring registration information including a position and a transmission power for each interfering device;
a step of estimating, for each interfering device, a terminal range in which there is a likelihood that a terminal device communicating with the interfering device is present based on the position and the transmission power; and
a step of transmitting a registration application including the terminal range to the control device.

Further, it is to be desired that a third aspect is a repeater for wireless communication using a control device that controls an amount of interference to which an interfered-with device whose wireless communication is to be protected is subjected by a plurality of interfering devices that perform wireless communication, the repeater including:
a processor unit; and
a memory storing a program executed by the processor unit,
in which the processor unit executes:
a process of acquiring registration information including a position and a transmission power for each interfering device;
a process of estimating, for each interfering device, a terminal range in which there is a likelihood that a terminal device communicating with the interfering device is present based on the position and the transmission power; and
an application process of transmitting a registration application including the terminal range to the control device.

Further, it is to be desired that a fourth aspect is an interference control program for wireless communication for realizing the repeater according to the third aspect, the interference control program including a program that causes
a processor unit to execute:
a process of acquiring registration information including a position and a transmission power for each interfering device;
a process of estimating, for each interfering device, a terminal range in which there is a likelihood that a terminal device communicating with the interfering device is present based on the position and the transmission power; and
an application process of transmitting a registration application including the terminal range to the control device.

### Advantageous Effects of Invention

According to the first to fourth aspects, it is possible to assume a range in which there is a likelihood that the terminal device is present around the interfering device as the position of the interference source that subjects the interfered-with device to interference. Therefore, according to the present disclosure, it is possible to appropriately protect the communication of the interfered-with device even when the communication of the terminal device affects the total amount of interference of the interfered-with device.

### BRIEF DESCRIPTION OF DRAWINGS

FIG. 1 is a diagram for describing an outline of an interference control system using CBRS which is a comparative example of a system of a first embodiment of the present disclosure;

FIG. 2 is a diagram for describing an outline of the interference control system of the first embodiment of the present disclosure;

FIG. 3 is a diagram for describing a configuration of an interfering device disposed in a carrier NW in FIG. 2;

FIG. 4 is a diagram for describing a configuration of a repeater illustrated in FIG. 2;

FIG. 5 is a diagram for describing features of the interference control system of the first embodiment of the present disclosure;

FIG. 6 is a flowchart for describing a flow of processing executed by the repeater in the first embodiment of the present disclosure;

FIG. 7 is a diagram for describing features of an interference control system of a second embodiment of the present disclosure;

FIG. 8 is a flowchart for describing a flow of processing executed by a repeater in the second embodiment of the present disclosure.

FIG. 9 is a diagram for describing features of an interference control system of a third embodiment of the present disclosure;

FIG. 10 is a flowchart for describing a flow of processing executed by a control device in the third embodiment of the present disclosure;

FIG. 11 is a diagram illustrating an example of a registration position of an interfering device registered in the control device by executing the routine illustrated in FIG. 10;

FIG. 12 is a diagram for describing features of an interference control system of a fourth embodiment of the present disclosure;

FIG. 13 is a flowchart for describing a flow of processing executed by a repeater in the fourth embodiment of the present disclosure;

FIG. 14 is a diagram for describing features of an interference control system of a fifth embodiment of the present disclosure; and

FIG. 15 is a flowchart for describing a flow of processing executed by a repeater in the fifth embodiment of the present disclosure.

### DESCRIPTION OF EMBODIMENTS

### First Embodiment

### [Comparative Example of First Embodiment]

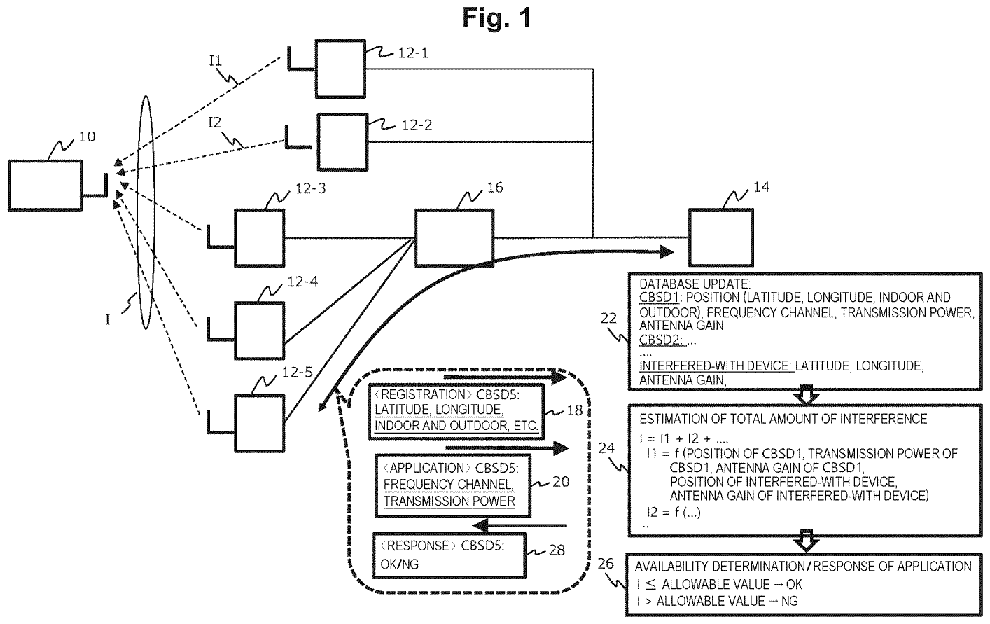

FIG. 1 is a diagram for describing an outline of an interference control system using CBRS. Hereinafter, as a comparative example of the interference control system of the first embodiment of the present disclosure, the configuration and operation of this system will be described.

The system illustrated in FIG. 1 includes an interfered-with device 10. The interfered-with device 10 is a wireless device that needs to protect communication quality, such as a radar system used by the government. The system illustrated in FIG. 1 also includes a plurality of interfering devices 12-1 to 12-5. The interfering device 12 is, for example, a wireless device assumed to be used in the private sector. The interfered-with device 10 and the interfering devices 12-1 to 12-5 can use overlapping frequency bands.

In a case where it is not necessary to distinguish the interfering devices 12-1 to 12-5 from each other, they will be hereinafter referred to as interfering devices 12 using reference numeral 12 without a suffix. Similarly, for the other elements described below, reference numerals with suffixes are used in a case where it is necessary to distinguish the same type of elements, whereas reference numerals without suffixes are used to indicate the elements in a case where it is not necessary to distinguish them.

A wireless signal emitted from the interfering device 12 may interfere with a wireless signal received by the interfered-with device 10. In FIG. 1, for example, the amount of interference caused by the interfering device 12-1 is represented as “I1”, and the amount of interference caused by the interfering device 12-2 is represented as “I2”. In addition, the total amount of interference, which is the sum of interference caused by each interfering device 12, is represented as “I” In order to protect the communication of the interfered-with device 10, it is necessary to reduce a total amount of interference I in the frequency channel used by the interfered-with device 10 to an allowable value or less.

In the system illustrated in FIG. 1, some interfering devices 12-1 and 12-2 are directly connected to a control device 14 of the CBRS. In addition, the remaining interfering devices 12-3 to 12-5 are connected to the control device 14 via a repeater 16. The repeater 16 can relay resource applications and responses between each of the plurality of interfering devices 12-3 to 12-5 and the control device 14.

In the system using the CBRS, each of the interfered-with device 10 and the interfering device 12 preregisters the ID, the position information, and the like of the device in the control device 14 prior to the start of communication. FIG. 1 illustrates a registration message 18 transmitted from the interfering device 12-5 to the control device 14 as an example thereof. The registration message 18 specifically includes the information described below.
1. Device ID=CBSD5
2. Latitude and longitude of installation position of the device
3. Information indicating whether the device is installed indoors or outdoors
4. Antenna gain of the device

After the pre-registration described above, each of the interfering devices 12 applies for a communication resource to be used toward the control device 14 when starting communication. FIG. 1 illustrates a state in which a resource application 20 including ID=CBSD5 is issued from the interfering device 12-5 to the control device 14. The resource application 20 specifically includes the information described below.
1. Frequency channel desired to be used for communication
2. Transmission power desired to be used for signal transmission

A database update unit 22 is formed inside the control device 14. The database update unit 22 updates information regarding frequency usage status and the like on the basis of the information obtained by the pre-registration, the information obtained by the resource application, furthermore the information of the response generated for the resource application, and the like. Specifically, the database generated by the database update unit 22 stores the following information for each of the interfering device 12 and the interfered-with device 10.

<Interfering Device 12> (CBSD1 to CBSD5)
1. Position (Latitude, Longitude, Indoor and Outdoor)
2. Available and In-Use Frequency Channels
3. Prescribed and In-Use Transmission Power
4. Antenna Gain

<Interfered-with device 10>
1. Position (Latitude, Longitude)
2. Antenna Gain
3. Frequency Channel Used
4. Allowable Amount of Interference

A total interference amount estimation unit 24 is formed inside the control device 14. The total interference amount estimation unit 24 estimates the total amount of interference I received by the interfered-with device 10. Specifically, first, amounts of interference I1 to I5 caused by the interfering devices 12 are calculated for each frequency channel used by the interfered-with device 10. For example, the amount of interference I1 caused by the interfering device 12-1 can be calculated by a known method as a function of the position of CBSD1, the transmission power of CBSD1, and the antenna gain of CBSD1, and the position of the interfered-with device 10, and the antenna gain of the interfered-with device 10. The same applies to the amounts of interference I2 to I5 of the other interfering devices 12. The total amount of interference I in each channel is calculated by calculating the sum of the amounts of interference I1 to I5 estimated or calculated in this manner for each frequency channel.

An availability determination/response unit 26 is further formed inside the control device 14. The availability determination/response unit 26 determines whether the total amount of interference I estimated in response to the resource application issued by any of the interfering devices 12 is equal to or less than an allowable value of interference with respect to the interfered-with device 10. In a case where the relationship of “total amount of interference I≤allowable value” is established, it can be determined that excessive interference does not occur in the interfered-with device 10 even when the resource application is accepted. In this case, the availability determination/response unit 26 generates an OK response to the resource application. On the other hand, in a case where the relationship of “total amount of interference>allowable value” is established, it can be determined that unacceptable interference occurs in the interfered-with device 10 when the resource application is accepted. In this case, the availability determination/response unit 26 generates an NG response to the resource application.

The response generated by the availability determination/response unit 26 is transmitted to the interfering device 12 directly or via the repeater 16. FIG. 1 illustrates a state in which a response 28 is transmitted from the control device 14 to the interfering device 12-5 via the repeater 16. Here, as illustrated, information of OK or NG is included together with ID=CBSD5.

When receiving an OK response to the resource application, the interfering device 12 starts communication using the frequency and transmission power for which the application is made. On the other hand, when receiving an NG response to the resource application, the resource application is performed again by changing the requested resource. According to the above processing, it is possible to continue to appropriately protect the communication of the interfered-with device 10 while permitting efficient communication to a large number of the interfering devices 12.

### [Configuration of First Embodiment]

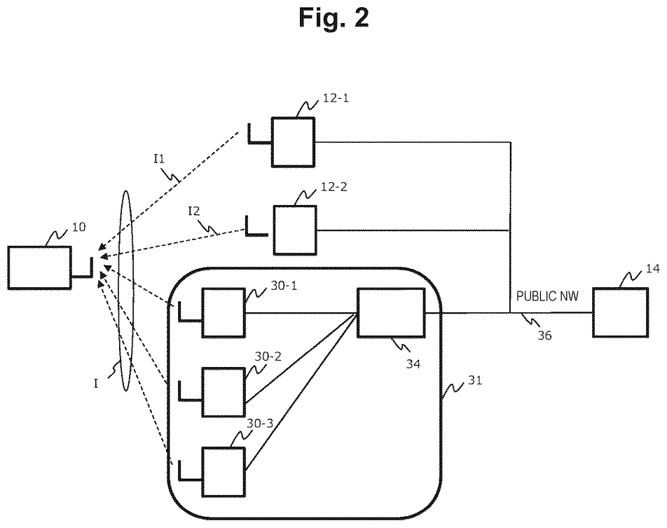

FIG. 2 illustrates a configuration of the interference control system of the first embodiment of the present disclosure. In the interference control system illustrated in FIG. 2, an optical access service provided by a specific communication carrier is incorporated in the configuration of the CBRS illustrated in FIG. 1. Note that, in FIG. 2, the same elements as those illustrated in FIG. 1 are denoted by the same reference numerals, and the description thereof will be omitted or simplified.

The system illustrated in FIG. 2 includes a plurality of interfering devices 30-1 to 30-3 together with interfering devices 12-1 and 12-2. The interfering devices 12-1 and 12-2 are disposed in a public network (NW) 36 together with the control device 14.

The interfering devices 30-1 to 30-3 are subscriber devices managed by subscribers of optical access services provided by communication carriers. For example, access points and the like of wireless LANs used by subscribers of optical access services correspond to the interfering devices 30-1 to 30-3.

The interfering device 30 is disposed in a network (hereinafter referred to as a “carrier NW 31”) managed by a communication carrier. Note that the interfering device 30 is connected to the carrier NW 31 via a subscriber network managed by the subscriber, but here, they are not distinguished and are referred to as a “carrier NW 31”.

A repeater 34 is further disposed in the carrier NW 31. The repeater 34 is an element constituting a main part of the interference control system of the present embodiment, and has a function of relaying registration information, a resource application, a response, and the like between the interfering device 30 and the control device 14.

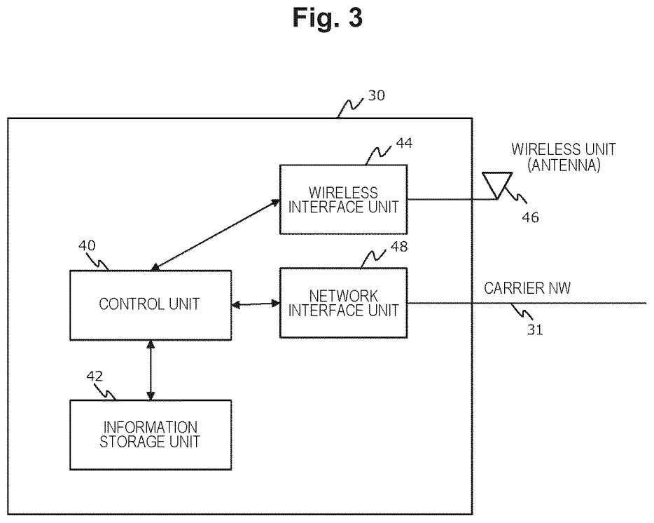

FIG. 3 is a block diagram for describing a configuration of the interfering device 30 illustrated in FIG. 2. As illustrated in FIG. 3, the interfering device 30 includes a control unit 40 and an information storage unit 42. The control unit 40 includes a processor unit (CPU). In addition, the information storage unit 42 includes a memory, and the memory stores a program to be executed by the CPU. The function of the control unit 40 is implemented by the CPU of the control unit 40 proceeding with the processing in accordance with the above-described program. The information storage unit 42 further stores resource information regarding an ID of the device, position information, a frequency used for communication, and the like.

The interfering device 30 includes a wireless interface unit 44. The wireless interface unit 44 can establish wireless communication with an external wireless device via an antenna 46. In addition, the wireless interface unit 44 can acquire GPS information of the device via the antenna 46. The interfering device 30 further includes a network interface unit 48. The network interface unit 48 can transmit and receive messages to and from the repeater 34 via the carrier NW 31.

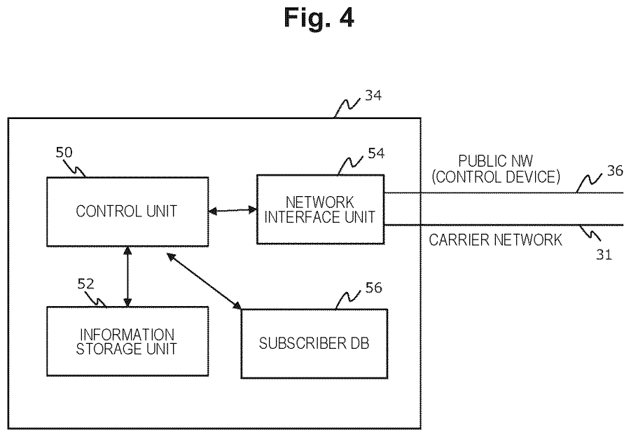

FIG. 4 is a block diagram for describing a configuration of the repeater 34 illustrated in FIG. 2. As illustrated in FIG. 4, the repeater 34 includes a control unit 50 and an information storage unit 52. The control unit 50 includes a processor unit (CPU). In addition, the information storage unit 52 includes a memory, and the memory stores a program to be executed by the CPU. The function of the control unit 50 is implemented by the CPU of the control unit 50 proceeding with the processing in accordance with the above-described program. This program can be recorded in a recording medium and provided to the repeater 34, and can also be provided to the repeater 34 via a network. The information storage unit 52 further stores information such as a content of a message to be relayed and a frequency usage status.

The repeater 34 includes a network interface unit 54. The network interface unit 54 can transmit and receive messages to and from each of the interfering devices 30 via the carrier NW 31, and can transmit and receive messages to and from the control device 14 via the public NW 36.

The repeater 34 further includes a subscriber database (DB) 56. The subscriber DB 56 stores information such as an ID and an address of a subscriber who manages each of the interfering devices 30.

### [Features of First Embodiment]

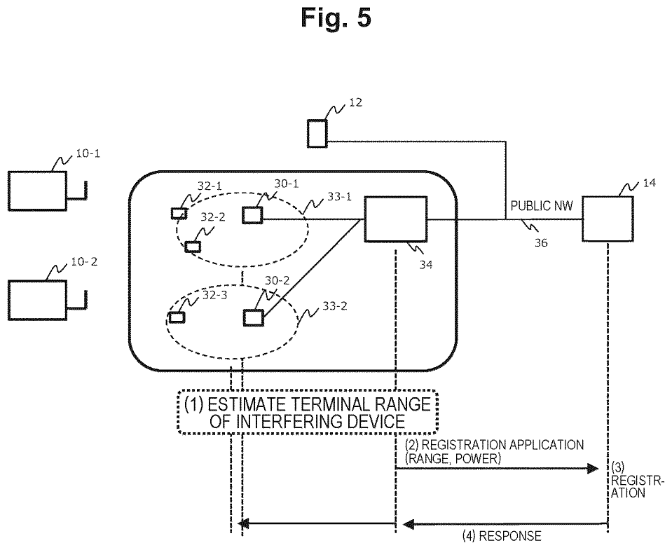

FIG. 5 is a diagram for describing features of the interference control system of the first embodiment of the present disclosure. Note that, in FIG. 5, the same elements as those illustrated in FIG. 2 are denoted by the same reference numerals, and the description thereof will be omitted or simplified.

The interference control system illustrated in FIG. 5 includes two interfered-with devices 10-1 and 10-2. Interfered-with devices 10-1 and 10-2 may be the same system or different systems. In addition, the frequency channels used by the interfered-with devices 10-1 and 10-2 may be the same, may overlap, or may be different.

In addition, the interference control system illustrated in FIG. 5 includes two interfering devices 30-1 and 30-2. Both of the interfering devices 30-1 and 30-2 can communicate with terminal devices present in the surroundings thereof.

In the example illustrated in FIG. 5, two terminal devices 32-1 and 32-2 communicate with the interfering device 30-1. In addition, one terminal device 32-3 communicates with the interfering device 30-2.

Hereinafter, for convenience of description, it is assumed that the terminal device 32 performs communication with the same transmission power as that of the interfering device 30 in communication.

In FIG. 5, a terminal range 33-1 of the interfering device 30-1 and a terminal range 33-2 of the interfering device 30-2 are indicated by broken-line ellipses. The terminal range 33-1 is a range in which the terminal device 32-1 can continue communication with the interfering device 30-1.

As illustrated in FIG. 5, in a case where the terminal device 32-1 is present at a position closer to the interfered-with device 10-1 than the interfering device 30-1, the transmission wave from the terminal device 32-1 subjects the interfered-with device 10-1 to larger interference than the transmission wave from the interfering device 30-1. In this case, the amount of interference received by the interfered-with device 10-1 due to the presence of the interfering device 30-1 should not be calculated on the basis of the position of the interfering device 30-1, but should be calculated on the basis of the position of the terminal device 32-1.

Similarly, under a situation where the terminal device 32-2 is present at a position closer to the interfered-with device 10-2 than the interfering device 30-1, the interfered-with device 10-2 is more greatly interfered by the transmission wave of the terminal device 32-2 than the transmission wave of the interfering device 30-1. Therefore, also in this case, the amount of interference received by the interfered-with device 10-2 due to the presence of the interfering device 30-1 should be calculated on the basis of the position of the terminal device 32-2. The above situation also applies to the calculation of the amount of interference caused by the second interfering device 30-2.

In this way, in order to accurately calculate the amount of interference received by the interfered-with device 10, it is necessary to calculate the amount of interference on the basis of the position of the terminal device 32 present around the interfering device 30 instead of the position itself of the interfering device 30. Then, the terminal device 32 can freely move within the terminal range 33. Therefore, in the present embodiment, the information about the position of the interfering device 30 includes the information about the terminal range 33 of the interfering device 30, and the information is registered in the control device 14.

FIG. 5 specifically illustrates that the processing described below is executed in time series in the interference control system of the present embodiment.
(1): The repeater 34 estimates the terminal range 33 of each of the interfering devices 30.
(2): The repeater 34 applies for registration of information of each of the interfering devices 30 including the terminal range 33 and the transmission power.
(3): The control device 14 registers the received information as information of each of the interfering devices 30.
(4): The control device 14 transmits a response issued to notify of the result of the registration approval to the interfering device 30 that has issued the registration application.

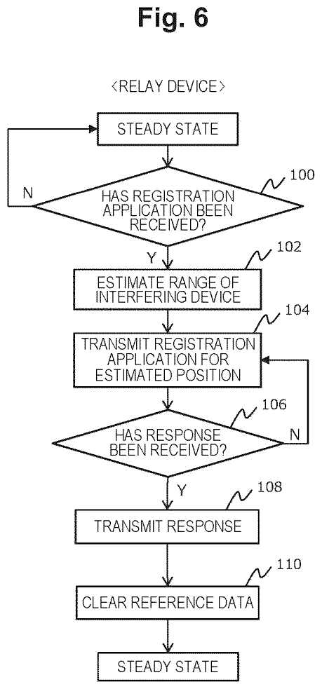

FIG. 6 is a flowchart for describing a flow of processing executed by the repeater 34 to implement the functions (1), (2), and (4) above. As illustrated in FIG. 6, the repeater 34 in the steady state determines whether or not a registration application has been received from any of the subordinate interfering devices 30 (step 100).

Similarly to the interfering device 12 of the CBRS, the interfering device 30 provides the following information to the repeater 34 at the time of a registration application.
1. Position (Latitude, Longitude, Indoor and Outdoor)
2. Available and In-Use Frequency Channels
3. Prescribed and In-Use Transmission Power
4. Antenna Gain

Upon receiving the registration application, the repeater 34 estimates the terminal range 33 of the interfering device 30 that has issued the application (step 102). The terminal range 33 is a range substantially reached by the transmission wave of the interfering device 30, and is calculated on the basis of the position of the interfering device 30, the predetermined transmission power, and the antenna gain.

When the above processing is completed, the repeater 34 transmits a registration application to the control device 14 for registering the position information including the estimated terminal range 33 (step 104).

Next, it is determined whether or not a response notifying of whether or not the registration application is possible has been received from the control device 14 within a certain period of time (step 106). In a case where the response from the control device 14 cannot be received, the process returns to step 104 to retransmit the registration application.

On the other hand, in a case where the reception of the response is recognized in step 106, the response is transmitted to the interfering device 30 that has issued the registration application (step 108).

Thereafter, the repeater 34 clears the reference data related to the position of the interfering device 30 (step 110), and returns to the steady state.

As described above, in the wireless communication system of the present embodiment, not only the position information but also the information including the terminal range 33 can be registered in the control device 14 for each interfering device 30. Since the position of the interfered-with device 10 is registered in the control device 14, it is possible to detect which position within the terminal range 33 is a position that greatly interferes with the interfered-with device 10. Therefore, according to the present embodiment, it is possible to more accurately calculate the total amount of interference received by the interfering device 30 and more appropriately protect the communication of the interfered-with device 10 as compared with the case where only the position of the interfered-with device 10 is registered in the control device 14.

### Second Embodiment

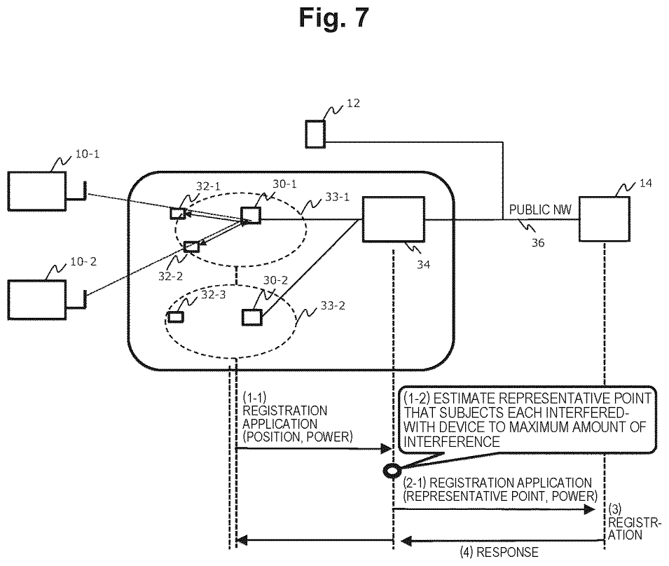

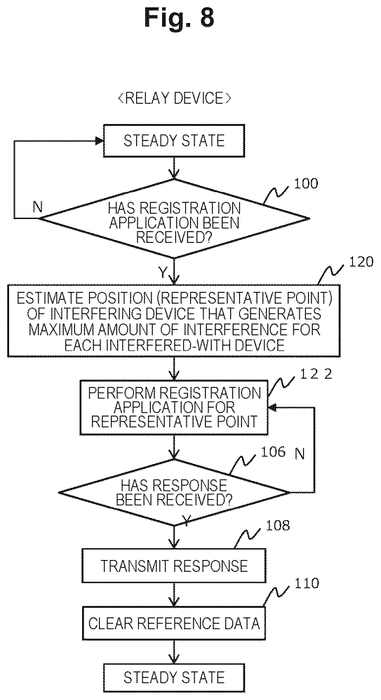

Next, a second embodiment of the present disclosure will be described with reference to FIGS. 7 and 8 together with FIGS. 2 to 4. The interference control system of the present embodiment can be implemented by the hardware configuration illustrated in FIGS. 2 to 4 as in the case of the first embodiment.

### [Features of Second Embodiment]

FIG. 7 is a diagram for describing features of the second embodiment of the present disclosure. Note that, in FIG. 7, elements or processes corresponding to those illustrated in FIG. 5 are denoted by the same reference numerals, and the description thereof will be omitted or simplified.

FIG. 7 illustrates that the processing described below is executed in time series in the interference control system of the present embodiment.
(1-1): Any of the interfering devices 30 transmits a registration application to the repeater 34. The registration application includes information about the position of the interfering device 30 and information about a transmission power that is predetermined or desired to be used.
(1-2): The repeater 34 estimates the terminal range 33 of the interfering device 30, and further estimates a position that subjects each of the interfered-with devices 10 to the maximum amount of interference in the terminal range 33. These positions and the position of the interfering device 30 are hereinafter referred to as “representative points” of the terminal range 33. Note that the terminal range 33 may include a plurality of terminal devices 32 at the same time, but in a case where they use the same frequency band, communication is performed by a time division method. Therefore, it is assumed here that there is no need to consider that the plurality of communications overlap and the amount of interference received by the interfered-with device 10 increases.
(2-1): The repeater 34 applies for registration of information about the interfering device 30 including the representative point and the transmission power.
(3), (4): As in the case of the first embodiment, the control device 14 performs registration processing, and a response is returned to the interfering device 30.

In FIG. 7, the terminal device 32-1 is present at a position closest to the interfered-with device 10-1 in the terminal range 33-1 of the interfering device 30-1. In addition, the terminal device 32-2 is present at a position closest to the interfered-with device 10-2 in the terminal range 33-1. These positions can be estimated when the terminal range 33-1 and the position of each of the interfered-with devices 10 are known.

In the present embodiment, the repeater 34 estimates the terminal range 33-1 as in the case of the first embodiment and acquires the position of each of the interfered-with devices 10 from the control device 14. Then, on the basis of both of them, the positions of the terminal devices 32-1 and 32-2 illustrated in FIG. 7, that is, the position that subjects each of the interfered-with devices 10 to the largest interference in the terminal range 33-1 are estimated. Similarly, for the other terminal range 33-2, the position that subjects each of the interfered-with devices 10 to the largest interference is estimated.

FIG. 8 is a flowchart for describing a flow of processing executed by the repeater 34 in the present embodiment to implement the functions (1-2), (2-1), and (4) above. The routine illustrated in FIG. 8 is similar to the routine illustrated in FIG. 6 above, except that steps 102 and 104 are replaced with steps 120 and 122, respectively. Here, the same steps as those illustrated in FIG. 6 are denoted by the same reference numerals, and redundant descriptions will be omitted or simplified.

According to the routine illustrated in FIG. 8, when the reception of the registration application from the interfering device 30 is recognized in step 100, the position of the interfering device 30 or the terminal device 32 that generates the maximum amount of interference is then estimated for each of the interfered-with devices 10 (step 120). In the example illustrated in FIG. 7, the following positions are estimated:
Position within the terminal range 33-1 that generates the maximum amount of interference for the interfered-with device 10-1;
Position within the terminal range 33-1 that generates the maximum amount of interference for the interfered-with device 10-2;
Position within the terminal range 33-2 that generates the maximum amount of interference for the interfered-with device 10-1; and
Position within the terminal range 33-2 that generates the maximum amount of interference for the interfered-with device 10-2.

When the above processing is completed, a registration application for the representative point including the position that subjects any of the interfered-with devices 10 to the maximum amount of interference and the position of the interfering device 30 is performed (step 122). Thereafter, as in the case of the first embodiment, the processing of step 106 and subsequent steps is executed.

Through the above processing, information including the representative point is registered in the control device 14 for each of the interfering devices 30. In this case, by referring to the representative point, for each of the interfering devices 30, the control device 14 can more easily find a position that subjects each of the interfered-with devices 10 to the largest interference as compared with the case of the first embodiment. Then, by calculating the total amount of interference of each of the interfered-with devices 10 on the basis of these positions, it is possible to appropriately protect communication of the interfered-with device 10 as in the case of the first embodiment. Therefore, according to the wireless communication system of the present embodiment, the effect obtained in the first embodiment can be more easily obtained.

### Third Embodiment

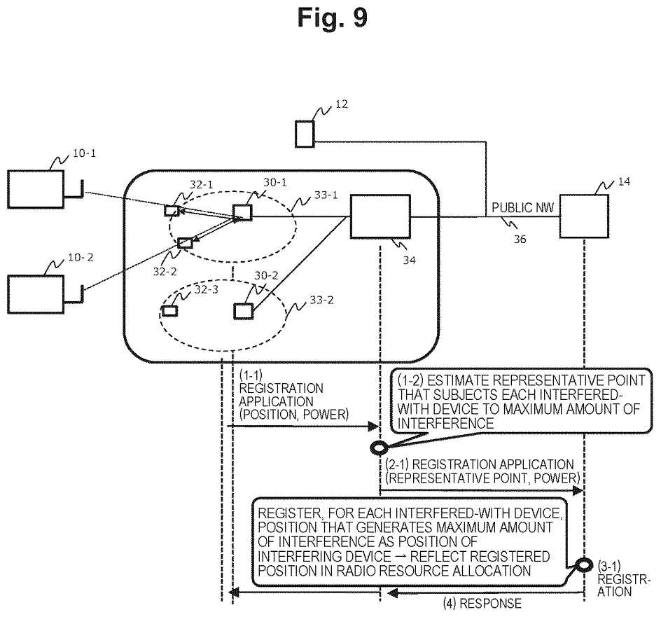

Next, a third embodiment of the present disclosure will be described with reference to FIGS. 9 to 11 together with FIGS. 2 to 4. The interference control system of the present embodiment can be implemented by the hardware configuration illustrated in FIGS. 2 to 4 as in the case of the first embodiment. Furthermore, in the present embodiment, the repeater 34 executes the routine illustrated in FIG. 8 described above, as in the case of the second embodiment. Accordingly, the control device 14 receives a registration application including the aforementioned representative point for each of the interfering devices 30 from the repeater 34.

### [Features of Third Embodiment]

FIG. 9 is a diagram for describing features of the third embodiment of the present disclosure. Note that, in FIG. 9, elements or processes corresponding to those illustrated in FIG. 7 are denoted by the same reference numerals, and the description thereof will be omitted or simplified.

FIG. 9 specifically illustrates that the processing described below is executed in time series in the interference control system of the present embodiment.
(1-1), (1-2), and (2-1): A registration application including a representative point is transmitted from each of the interfering devices 30 to the control device 14 in a procedure similar to that in the second embodiment.
(3-1): The control device 14 registers, for each interfered-with device 10, a position within the terminal range 33 that generates the maximum amount of interference as a position of each interfering device 30.
(4): As in the cases of the first and second embodiments, a response is returned from the control device 14 to the interfering device 30.

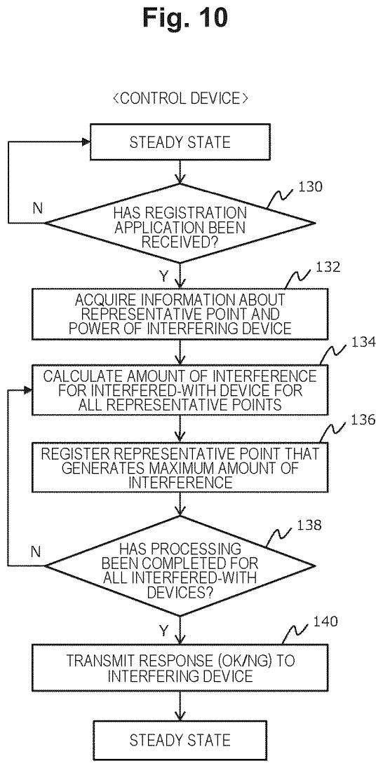

FIG. 10 is a flowchart for describing a flow of processing executed in the present embodiment to implement the functions (3-1) and (4) above. Specifically, the routine illustrated in FIG. 10 is executed by a control processor unit provided in the control device 14 advancing processing according to a program stored in the control device 14.

As illustrated in FIG. 10, the control device 14 determines whether or not a registration application has been received from the repeater 34 in the steady state (step 130). As described above, the registration application includes information indicating the representative point of the interfering device 30 that has issued the registration application, that is, the position of the interfering device 30 that has issued the registration application, and the position that subjects any of the interfered-with devices 10 to the maximum amount of interference.

When the reception of the registration application is recognized, the control device 14 acquires information about the representative point and the transmission power included therein (step 132).

Next, the control device 14 calculates the amount of interference for the specific interfered-with device 10 for all the acquired representative points (step 134). The amount of interference is calculated on the basis of the position of the interfered-with device 10 and the position of each representative point.

Then, all the calculated results are compared to select a representative point that generates the maximum amount of interference. Then, the selected representative point is registered as the position of the interfering device 30 for the interfered-with device 10 (step 136). Note that, in a simple manner, the calculation of the amount of interference for each of the representative points may be omitted, and the representative point located closest to the interfered-with device 10 may be selected as the point that generates the maximum amount of interference.

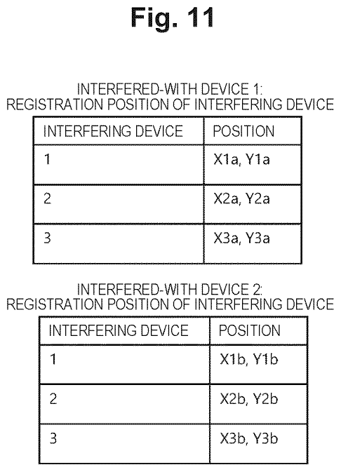

FIG. 11 illustrates a registration list obtained by accumulating registration in the processing of step 136 above. The first row of the upper list in FIG. 11 indicates that (X1a, Y1a) is registered as the position of the “interfering device 1” for the “interfered-with device 1”. This registration is performed in the following situations.
(1) This registration application was issued from the “interfering device 1”.
(2) The registration application of the interfering device 1 included (X1a, Y1a), (X1b, Y1b) . . . as representative points.
(3) The target for calculating the amount of interference in step 134 above was the “interfered-with device 1”.
(4) In step 136 above, (X1a, Y1a) was selected as the representative point that generates the maximum amount of interference.

In the routine illustrated in FIG. 10, when the registration processing in step 136 is completed, next, it is determined whether or not the processing has been completed for all the interfered-with devices 10 present around the interfering device 30 that has issued the registration application (step 138). As a result, in a case where it is determined that the above processing has not been executed for all the interfered-with devices 10 yet, the interfered-with device 10 is changed, and the processing of step 134 and subsequent steps is executed again.

For example, the processing target of step 134 is changed from the interfered-with device 1 to the interfered-with device 2. Next, in step 136, (X1b, Y1b) is selected as a representative point that generates the maximum amount of interference. In this case, the position of the interfering device 1 for the interfered-with device 2 is registered as illustrated in the first row of the lower list in FIG. 11. Then, when it is determined in step 138 that the processing of all the interfered-with devices 10 has been completed for the interfering device 1 that has issued the current application, a response notifying of whether or not the registration is possible is transmitted to the interfering device 1 that has issued the registration application (step 140).

Thereafter, when a registration application is issued from the interfering device 2 and the routine illustrated in FIG. 10 is executed, the registration in the second row of each of the upper and lower lists in FIG. 11 is performed. Further, when a registration application is issued from the interfering device 3 and the routine illustrated in FIG. 10 is executed, the registration in the third row of each of the upper and lower lists in FIG. 11 is performed.

The position of the interfering device 30 registered in this manner is a position that generates the maximum amount of interference for each of the interfered-with devices 10 in each of the terminal ranges 33. Therefore, the control device 14 of the present embodiment can specify the position derived from the interfering device 30 that generates the maximum amount of interference for each of the interfering devices 30 more easily than the case of the second embodiment only by referring to the result of the registration illustrated in FIG. 11. Then, if such specification can be made, it is possible to appropriately protect communication of the interfered-with device 10 as in the case of the second embodiment. Therefore, according to the wireless communication system of the present embodiment, the effect obtained in the second embodiment can be more easily obtained.

Meanwhile, in the third embodiment described above, the repeater 34 executes the routine illustrated in FIG. 8 to estimate a representative point, and notifies the control device 14 of the representative point. However, the present disclosure is not limited thereto. For example, the repeater 34 may execute a routine illustrated in FIG. 6 instead of FIG. 8 and notify the control device 14 of the terminal range 33. In this case, the control device 14 estimates a position that subjects each of the interfered-with devices 10 to the maximum amount of interference in the terminal range 33. Even with such a configuration, it is possible to protect communication of the interfered-with device 10 as in the case of the above-described third embodiment.

### Fourth Embodiment

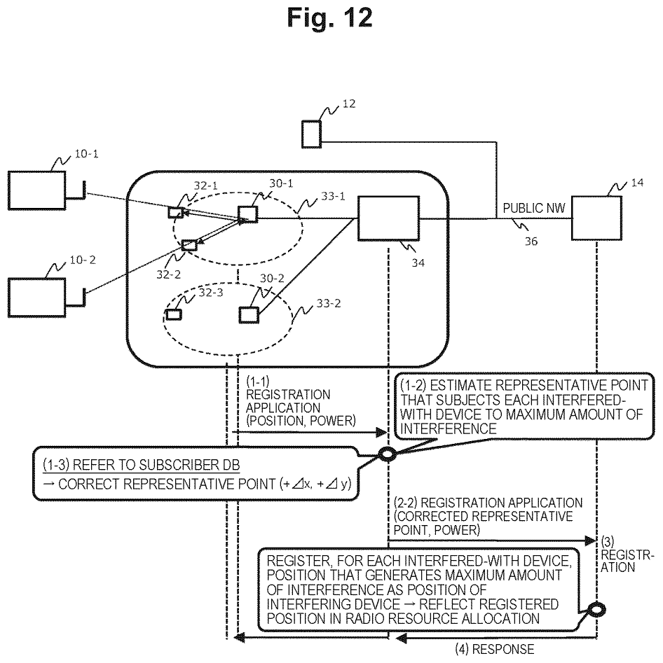

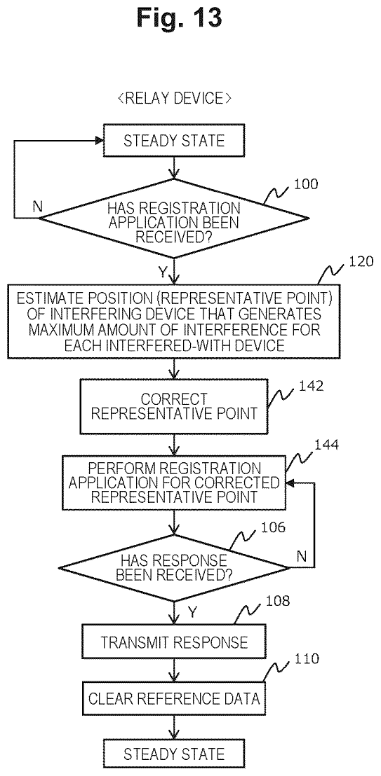

Next, a fourth embodiment of the present disclosure will be described with reference to FIGS. 12 and 13 together with FIGS. 2 to 4. The interference control system of the present embodiment can be implemented by the hardware configuration illustrated in FIGS. 2 to 4 as in the case of the first embodiment. However, in the present embodiment, construction information of each interfering device 30 is stored in the subscriber DB 56 of the repeater 34.

The interfering device 30 is installed in a site managed by the subscriber. The position of the interfering device 30 preregistered in the control device 14 is usually a reference position of the site. However, the installation position of the interfering device 30 does not necessarily match the reference position. At the time of installation construction of the interfering device 30, a difference between the reference position of the site and the actual installation position may be recorded as a construction record. In the present embodiment, it is assumed that the above construction record is stored in the subscriber DB 56.

### [Features of Fourth Embodiment]

FIG. 12 is a diagram for describing features of the fourth embodiment of the present disclosure. Note that, in FIG. 12, elements or processes corresponding to those illustrated in FIG. 5, 7, or 9 are denoted by the same reference numerals, and the description thereof will be omitted or simplified.

FIG. 12 specifically illustrates that the processing described below is executed in time series in the interference control system of the present embodiment.
(1-1) and (1-2): A representative point of each of the interfering devices 30 that generate the maximum amount of interference for each of the interfered-with devices 10 is estimated in a procedure similar to those in the second and third embodiments.
(1-3): The repeater 34 corrects the representative point of the interfering device 30 with reference to the subscriber DB 56. In the subscriber DB 56, for example, an error of an actual installation position with respect to a reference position of a site is stored as a difference between latitude and longitude (+Δx, +Δy). Here, the above difference is added to the latitude and longitude of the reference position to correct the position of the interfering device 30. Similarly, in the terminal range 33, the latitude and longitude are also corrected at a position specified as the position that subjects any of the interfered-with devices 10 to the maximum amount of interference. However, the above error is not limited to the difference between the latitude and the longitude. For example, the above error may be represented by a difference in the distance in the east-west direction and a difference in the distance in the north-south direction.
(2-2): The repeater 34 applies for registration of information about the interfering device 30 including the corrected representative point and transmission power.
(3), (4): As in the case of the first or second embodiment, the control device 14 performs registration processing, and a response is returned to the interfering device 30.

FIG. 13 is a flowchart for describing a flow of processing executed by the repeater 34 in the present embodiment to implement the functions (1-2), (1-3), (2-2), and (4) above. The routine illustrated in FIG. 13 is similar to the routine illustrated in FIG. 8 above, except that step 122 is replaced with steps 142 and 144. Here, the same steps as those illustrated in FIG. 8 are denoted by the same reference numerals, and redundant descriptions will be omitted or simplified.

According to the routine illustrated in FIG. 13, after the representative point of the interfering device 30 that generates the maximum amount of interference is estimated for each of the interfered-with devices 10 in step 120, the representative point is corrected (step 142). Specifically, first, the error (+Δx, +Δy) of the installation position of the interfering device 30 is read from the subscriber DB 56. Next, the error is added to each of the estimated representative points.

When the above processing is completed, a registration application for the corrected representative point is performed (step 144). Thereafter, as in the case of the first or second embodiment, the processing of step 106 and subsequent steps is executed.

Through the above processing, information including the corrected representative point is registered in the control device 14 for each of the interfering devices 30. In this case, the control device 14 can more accurately calculate the total amount of interference received by each of the interfered-with devices 10 as compared with the cases of the first to third embodiments. Therefore, according to the wireless communication system of the present embodiment, it is possible to more appropriately protect the communication of the interfered-with device 10 as compared with the cases of the first to third embodiments.

Meanwhile, in the fourth embodiment described above, a technology of correcting a representative point is combined with the technology of the second embodiment. However, the present disclosure is not limited thereto. For example, the technology of correcting the representative point may be combined with the technology of the third embodiment. In this case, the control device 14 generates a registration list as illustrated in FIG. 11 on the basis of the corrected representative points. Then, by calculating the total amount of interference on the basis of the registration list, a wireless communication system that can more appropriately protect communication of the interfered-with device 10 is implemented as compared with the case of Embodiment 3.

Further, in the fourth embodiment described above, the representative point is corrected by the repeater 34, but the present disclosure is not limited thereto. For example, the repeater 34 may provide only the error between the registration position of the interfering device 30 and the actual installation position to the control device 14, and the control device 14 may be caused to correct the representative point.

### Fifth Embodiment

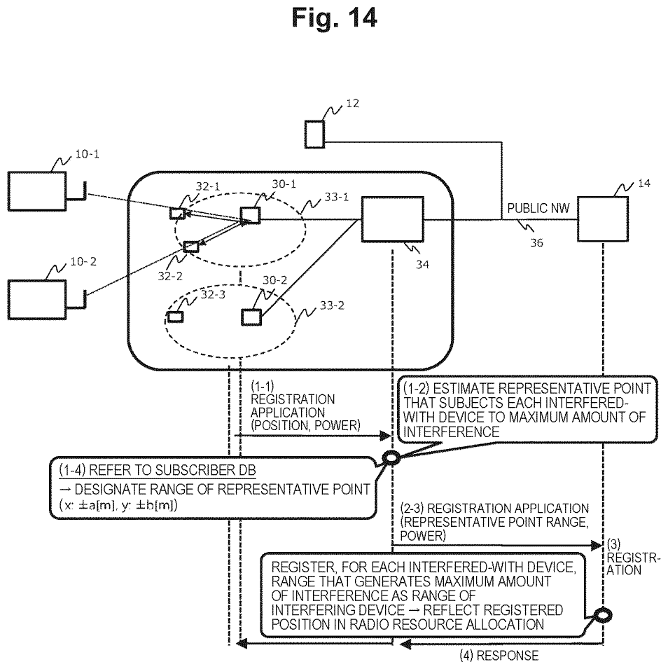

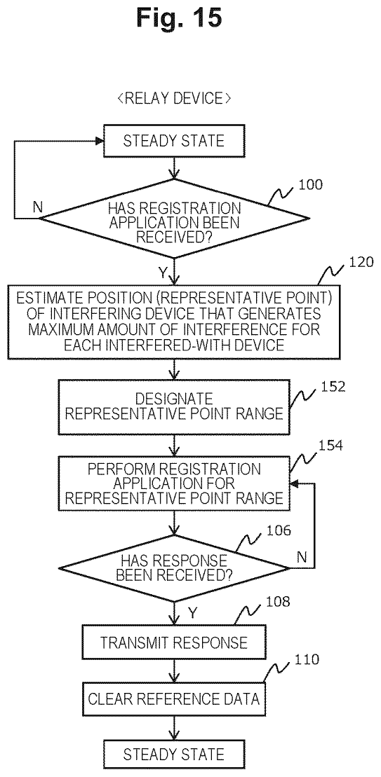

Next, a fifth embodiment of the present disclosure will be described with reference to FIGS. 14 and 15 together with FIGS. 2 to 4. The interference control system of the present embodiment can be implemented by the hardware configuration illustrated in FIGS. 2 to 4 as in the case of the first embodiment. However, in the present embodiment, construction information of each interfering device 30 is stored in the subscriber DB 56 of the repeater 34 as in the case of the fourth embodiment.

The interfering device 30 is installed in a site managed by the subscriber. The position of the interfering device 30 preregistered in the control device 14 is usually a reference position of the site. However, the interfering device 30 may be relocated within the site, and its position may change within the range of the site. In the present embodiment, the width of the site of the subscriber, for example, a width of ±a [m] in the east-west direction and a width of ±b [m] in the north-south direction are recorded at the time of installation construction of the interfering device 30. Then, it is assumed that the information is stored in the subscriber DB 56 as a construction record.

### [Features of Fifth Embodiment]

FIG. 14 is a diagram for describing features of the fifth embodiment of the present disclosure. Note that, in FIG. 14, elements or processes corresponding to those illustrated in FIG. 5, 7, 9, or 12 are denoted by the same reference numerals, and the description thereof will be omitted or simplified.

FIG. 14 specifically illustrates that the processing described below is executed in time series in the interference control system of the present embodiment.
(1-1) and (1-2): A representative point of each of the interfering devices 30 that generate the maximum amount of interference for each of the interfered-with devices 10 is estimated in a procedure similar to those in the second to fourth embodiments.
(1-4): The repeater 34 designates a range of the representative point of the interfering device 30 with reference to the subscriber DB 56. The subscriber DB 56 stores, for example, information indicating the range of the site in two dimensions, for example, information such as a width ±a [m] in the east-west direction and a width ±b [m] in the north-south direction. Here, the above width is designated as the reference position of the site. Similarly, in the terminal range 33, the above width is also designated at a position specified as the position that subjects any of the interfered-with devices 10 to the maximum amount of interference. However, the above width is not limited to the distance in the east-west direction and the north-south method, and may be expressed by, for example, width equivalent to latitude and longitude.
(2-3): The repeater 34 issues a registration application for information including a designated representative point in a range (hereinafter referred to as a “representative point range”) and a transmission power.
(3), (4): As in the case of the first, second, or fourth embodiment, the control device 14 performs registration processing, and a response is returned to the interfering device 30.

FIG. 15 is a flowchart for describing a flow of processing executed by the repeater 34 in the present embodiment to implement the functions (1-2), (1-4), (2-3), and (4) above. The routine illustrated in FIG. 15 is similar to the routine illustrated in FIG. 13 above, except that steps 142 and 144 are replaced with steps 152 and 154, respectively. Here, the same steps as those illustrated in FIG. 13 are denoted by the same reference numerals, and redundant descriptions will be omitted or simplified.

According to the routine illustrated in FIG. 15, after the representative point of the interfering device 30 that generates the maximum amount of interference is estimated for each of the interfered-with devices 10 in step 120, the range of the representative point is designated (step 152). Specifically, first, the range (x: ±a [m], y: ±b [m]) of the installation position of the interfering device 30 is read from the subscriber DB 56. Then, the range is designated for each of the estimated representative points.

When the above processing ends, a registration application for the representative point range is performed (step 154). Thereafter, as in the case of the first, second, or fourth embodiment, the processing of step 106 and subsequent steps is executed.

Through the above processing, information including the representative point range is registered in the control device 14 for each of the interfering devices 30. When the control device 14 calculates the amount of interference received by the interfering device 30 on the basis of the position before the relocation even though the interfered-with device 10 is relocated in the site after the installation, the amount of interference may be evaluated excessively with respect to the actual value. In that case, a situation may arise in which the communication of the interfered-with device 10 is not appropriately protected.

In the present embodiment, the control device 14 calculates the amount of interference received by the interfered-with device 10 assuming that the interfering device 30 is installed at a position that generates the maximum amount of interference in the representative point range. Specifically, the amount of interference is calculated assuming that the interfering device 30 is present at a position close to the interfered-with device 10 in the representative point range. According to such a method, it is possible to reliably prevent the amount of interference from being excessively evaluated due to the relocation of the interfering device 30. Therefore, according to the wireless communication system of the present embodiment, it is possible to more appropriately protect the communication of the interfered-with device 10 as compared with the cases of the first to fourth embodiments.

Meanwhile, in the fifth embodiment described above, a technology of designating a range of a representative point is combined with the technology of the second embodiment. However, the present disclosure is not limited thereto. For example, a technology for designating the range of the representative point may be combined with the technology of the third embodiment. In this case, the control device 14 generates a registration list as illustrated in FIG. 11 on the basis of the representative point range. Then, by calculating the total amount of interference on the basis of the registration list, a wireless communication system that can more appropriately protect communication of the interfered-with device 10 is implemented as compared with the case of Embodiment 3.

Further, in the fifth embodiment described above, the representative point range is designated by the repeater 34, but the present disclosure is not limited thereto. For example, the repeater 34 may provide only the width of the installation position of the interfering device 30 to the control device 14, and the control device 14 may be caused to designate the representative point range.

### REFERENCE NUMERALS LIST

10, 10-1, 10-2, 10-3 Interfered-with device
12, 12-1 to 12-5, 30, 30-1 to 30-4 Interfering device
14 Control device
31 Carrier network (carrier NW)
32, 32-1, 32-2, 32-3 Terminal range
33, 33-1, 33-2 Terminal range
34 Repeater
36 Public network (public NW)
50 Control unit
52 Information storage unit

1. An interference control system for wireless communication, the interference control system comprising: a plurality of interfering wireless communicators that perform wireless communication; an interfered-with wireless communicator whose wireless communication is to be protected; and a controller that controls an amount of interference to which the interfered-with device wireless communicator is subjected by the interfering wireless communicator,
wherein a repeater disposed between the interfering wireless communicator and the controller includes a processor and a memory storing a program executed by the processor, and
the processor executes:
a process of acquiring registration information including a position and a transmission power for each interfering wireless communicator;
a process of estimating, for each interfering wireless communicator, a terminal range in which there is a likelihood that a terminal wireless communicator communicating with the interfering wireless communicator is present based on the position and the transmission power; and
an application process of transmitting a registration application including the terminal range to the controller.

2. The interference control system for wireless communication according to claim 1, wherein:
the processor further executes:
a process of acquiring a position of the interfered-with wireless communicator; and
a process of estimating a representative point of the terminal range for each interfering wireless communicator based on the position of the interfered-with device wireless communicator,
the representative point includes a position within the terminal range that subjects any interfered-with wireless communicator to a maximum amount of interference, and
the application process includes a process of transmitting a registration application expressing the terminal range with information including the representative point to the controller.

3. The interference control system for wireless communication according to claim 1, wherein:
the controller includes a control processor, and
the control processor executes:
a process of acquiring a position of the interfered-with wireless communicator;
a process of reading the terminal range from the registration application;
a process of estimating a representative point that subjects the interfered-with wireless communicator to a maximum amount of interference in the terminal range based on the position of the interfered-with wireless communicator;
a process of registering the representative point estimated by the process as a position of an interfering wireless communicator that has issued the registration application for the interfered-with wireless communicator;
a process of calculating a total amount of interference received by the interfered-with wireless communicator based on the representative point registered by the process; and
a process of determining allocation of a communication resource to each of the interfering wireless communicators based on the total amount of interference.

4. The interference control system for wireless communication according to claim 2, further comprising:
a subscriber database that stores information about a position of each of the interfering wireless communicators,
wherein the subscriber database stores construction information about an actual installation position of the interfering wireless communicator, and
the processor further executes:
a process of acquiring an error between the position of the interfering wireless communicator acquired as the registration information and the actual installation position based on the construction information; and
a process of correcting the representative point based on the error.

5. The interference control system for wireless communication according to claim 2, further comprising:
a subscriber database that stores information about a position of each of the interfering wireless communicators,
wherein the subscriber database stores construction information about a range in which there is a likelihood that the interfering wireless communicator is relocated, and
the processor further executes a process of converting information about the representative point into information about a representative point range including information about the range based on the construction information.

6. An interference control method for wireless communication using a controller that controls an amount of interference to which an interfered-with wireless communicator whose wireless communication is to be protected is subjected by a plurality of interfering wireless communicators that perform wireless communication, the interference control method comprising:
a step of acquiring registration information including a position and a transmission power for each interfering wireless communicator;
a step of estimating, for each interfering wireless communicator, a terminal range in which there is a likelihood that a terminal wireless communicator communicating with the interfering wireless communicator is present based on the position and the transmission power; and
a step of transmitting a registration application including the terminal range to the controller.

7. A repeater for wireless communication using a controller that controls an amount of interference to which an interfered-with wireless communicator whose wireless communication is to be protected is subjected by a plurality of interfering wireless communicators that perform wireless communication, the repeater comprising:
a processor; and
a memory storing a program executed by the processor,
wherein the processor executes:
a process of acquiring registration information including a position and a transmission power for each interfering wireless communicator;
a process of estimating, for each interfering wireless communicator, a terminal range in which there is a likelihood that a terminal wireless communicator communicating with the interfering wireless communicator is present based on the position and the transmission power; and
an application process of transmitting a registration application including the terminal range to the controller.

8. A non-transitory program memory readable by machine for wireless communication for realizing the repeater according to claim 7, the program instructs a processor to execute:
a process of acquiring registration information including a position and a transmission power for each interfering wireless communicator;
a process of estimating, for each interfering wireless communicator, a terminal range in which there is a likelihood that a terminal wireless communicator communicating with the interfering wireless communicator is present based on the position and the transmission power; and
an application process of transmitting a registration application including the terminal range to the controller.

9. The interference control system for wireless communication according to claim 2,
wherein the controller includes
a control processor, and
the control processor executes:
a process of acquiring a position of the interfered-with wireless communicator;
a process of reading the terminal range from the registration application;
a process of estimating a representative point that subjects the interfered-with wireless communicator to a maximum amount of interference in the terminal range based on the position of the interfered-with wireless communicator;
a process of registering the representative point estimated by the process as a position of an interfering wireless communicator that has issued the registration application for the interfered-with wireless communicator;
a process of calculating a total amount of interference received by the interfered-with wireless communicator based on the representative point registered by the process; and
a process of determining allocation of a communication resource to each of the interfering wireless communicators based on the total amount of interference.

10. The interference control system for wireless communication according to claim 3, further comprising:
a subscriber database that stores information about a position of each of the interfering wireless communicators,
wherein the subscriber database stores construction information about an actual installation position of the interfering wireless communicator, and
the processor further executes:
a process of acquiring an error between the position of the interfering wireless communicator acquired as the registration information and the actual installation position based on the construction information; and
a process of correcting the representative point based on the error.

11. The interference control system for wireless communication according to claim 3, further comprising:
a subscriber database that stores information about a position of each of the interfering wireless communicators,
wherein the subscriber database stores construction information about a range in which there is a likelihood that the interfering wireless communicator is relocated, and
the processor further executes a process of converting information about the representative point into information about a representative point range including information about the range based on the construction information.
